(19) United States
(12) Patent Application Publication
(10) Pub. No.: US 2024/0014407 A1
(43) Pub. Date: Jan. 11, 2024

(54) Monolithic Electrode Supported Electro-Chemical Device Stack

(71) Applicant: Hansong Huang, Pleasanton, CA (US)

(72) Inventor: Hansong Huang, Pleasanton, CA (US)

(21) Appl. No.: 17/861,964

(22) Filed: Jul. 11, 2022

(51) Int. Cl. H01M 4/88; H01M 8/2432; H01M 8/2404

(52) U.S. Cl. CPC H01M 4/8875; H01M 8/2432; H01M 8/2404

(57) ABSTRACT

A design of and the process for forming a monolithic electrode supported electro-chemical device is provided. The electro-chemical device stack can be a solid oxide fuel cell stack. The monolithic stack comprises multiple planar cells connected in serial by planar ceramic interconnects. The cells have gas channels embedded in electrode layers in both anode and cathode sides. Thin ceramic electrolyte and interconnect are sandwiched between electrodes. The process comprises the steps of a). forming green cells by laminating green tapes of anode, electrolyte, and cathode, b). forming a green stack by laminating cells and interconnects, c). firing the green stack to form a stack scaffold, d). covering the stack exterior surfaces with a hermetic coating, and f). infiltrating catalysts into porous electrodes through gas channels to form an active stack.

### BACKGROUND OF THE INVENTION

An electro-chemical device, such as solid oxide fuel cell or solid oxide electrolysis cell, converts between chemical energy and electrical energy. Specifically, a solid oxide fuel cell (SOFC) is an electro-chemical device that converts chemical energy directly to electrical energy through oxidation of a fuel gas. The device is generally composed of ceramics, using an oxygen ion conducting metal oxide derived ceramics as the electrolyte. The electrolyte should be solid, non-porous, or only having closed porosity. Most oxygen ion conducting metal oxides only demonstrate sufficient ion conductivity at elevated temperatures above of 500° C. for ceria based or 600° C. for zirconia based materials. Under differential oxygen partial pressure between the two sides of electrolyte, oxygen ions are transported from cathode to the anode to oxide fuel in anode, generating electrical potential in the process.

Solid oxide fuel cells are advantageous to other fuel cell varieties in having high efficiency and can use other fuel sources in addition to hydrogen, such as natural gas, propane, methanol, kerosene, and diesel, among others, because SOFCs operate at sufficiently high temperature to allow for internal fuel reformation. When operate under hydrogen fuel, unlike proton-exchanged membrane fuel cells, SOFCs do not require high purity hydrogen. In fact, natural gas reformate gas can be directly used as fuel.

A SOFC cell includes a cathode where oxygen is reduced, an electrolyte through which oxygen ions are transported, and an anode where fuel is oxidized. The electrodes must be composed of materials or composites of materials that are a). capable of catalyzing the electro-chemical reactions, b). conducting electrons and oxygen ions, c). stable in oxidizing (in cathode) and reducing (in anode) environments, d). porous so that gas can permeate through, e). mechanically compatible with electrolyte in term of such as thermal expansion and re-oxidization (in anode) dimensional stability, and f). providing sufficient mechanical rigidity and strength as structure supports. Furthermore, the multi-layer structure has to be compatible with ceramic fabrication techniques, and ideally using conventional methods such as tape-casting, screen-printing, as well as standard sintering process to keep the cost low. The complexity of selecting materials and designs that can meet the matrices of electro-chemical, mechanical, fabrication, and economical constraints are well documented in the literatures.

Solid oxide fuel cells may be manufactured in several forms. Planar designs are commonly used for high space efficiency and low manufacturing cost. A planar SOFC cell generally has a thick supporting layer, typically anode layer, of 0.5-1 mm thick, upon which thin anode, electrolyte, and cathode layers are deposited by different fabrication processes. A variety of material combinations and fabrication processes can be employed. For example, the electrolyte is formed with yttria-stabilized zirconia (YSZ), sandwiched between a cathode, such as lanthanum strontium manganate (LSM) and YSZ composites, and an anode, such as nickel and YSZ composites. To reduce the ionic resistance, electrolyte should have minimal thickness, such as less than 10 μm when tape-casted or screen-printed. Smaller thickness can be achieved with more expensive techniques. Electrolyte should be non-porous or without open porosity to prevent gas cross-leak. The electrodes should have sufficient porosity to allow gas diffusion and provide sufficient triple phase boundary sites facilitating the chemical reactions. With the anode layer providing structural support, the cathode layer thickness can be minimized, such as 20-100 μm, to reduce electronical resistance. The electrode and electrolyte can be individually deposited to the anode support and fired in sequence, or they can be formed and fired with the anode support. In some examples, only anode and electrolyte are formed and fired together, while cathode is deposited after firing.

Co-firing multiple active ceramic materials at high temperature can impose significant constraints on the material choices and processing conditions because a). anode, cathode, and electrolyte materials have different compositions and generally different sintering shrinkage that can lead to cracking during sintering. b). anode, cathode, and electrolyte materials generally have different thermal expansion coefficients (CTE) that can result in excessive internal stress during post sinter cooling down or thermal cycle. The internal stresses generally limit the cell structure to only one thick layer as the structure support. The electrodes are formed of certain composition and microstructure to achieve similar CTE to electrolyte. The process of materials is complex, generally entailing trade-offs in the mechanical strength or electro-chemical performance. The constraint of only one thick electrode layer also prevents gas delivery channel from being embedded in the cell, necessitating interconnects with gas channels, increasing complexity and gas diffusion resistance. c). high sintering temperatures, such as >1300° C., are often required to achieve good diffusion bonding between layers and fully densifying electrolyte and interconnect. At high temperature, some components of fuel cell can react to form insulating phases, such as, SrZrO₃ or La₂Zr₂O₇, that degrades performance.

Infiltration techniques have been used to remove some of the constraints. An electrode scaffold is first formed and sintered together with electrolyte layer into a homogeneous structure, wherein the electrode scaffold is formed with the same material or material of substantially similar sintering shrinkage and thermal expansion coefficient as the electrolyte layer. Active catalysts are infiltrated into porous electrode scaffold and activated by heat-treatment. The infiltration process offers several benefits: a). the electrolyte and electrode scaffold layers composed of the same material or materials deforming similarly during sintering and thermal cycle, ensuring uniform deformation with minimal internal stresses. b). avoiding exposure of catalysts to high temperature that promotes undesirable chemical reactions or elemental diffusion, c). infiltrated catalysts forming nano-scale particulate coating on porous electrode scaffold surfaces, generally reducing electro-chemical reaction activation energy, d). reducing the CTE of the formed composites to a level similar to the electrode scaffold material, and e). reducing or even eliminating anode re-dox volume changes.

In consistence with literature convention, reference herein to “scaffold” is reference to porous ceramic layer or component before catalysts are infiltrated. For example, a cell scaffold is reference to a cell structure having porous electrode backbone, but before catalysts infiltrated into electrode. A stack scaffold is reference to a stack structure composed of cell scaffolds.

Since an SOFC cell typically provides an electrical potential of approximately 1.1 volts, practical application of SOFC may be arranged in stacks composed of many cells with interconnects joining and conducting current between immediately adjacent cell cathode and anode. Generally, the interconnects are formed with high temperature alloy metals that are mechanically assembled with sintered cells. Fuel and air are delivered to cell anode and cathode sides respectively, through either gas channels embedded in interconnect, or metallic mesh layer between interconnect and cell. A typical stack structure is shown in FIG. 1. Besides the cells and interconnects, a stack requires: a). anode and cathode frames to support and separate cell and interconnect and provide gas channels, b). sealing layers between cell and interconnect that become viscous at operation temperature to prevent gas leakage and accommodate component relative movement, and c). compliant conductive layers, such as metallic mesh, for electrical contact between cell and interconnect. For maintaining gas sealing and good electrical conduction throughout the assembled stack, the interconnects and other components are generally required to have high geometrical tolerance, especially in flatness; and the assembled stack is placed under permanent compressive loading to flatten cells and interconnects, maintain electrical contacts between layers, and provide compression force on inter-layer glass seals. The compressive loading is applied through thick end plates bolted together, made from high temperature creep resistance special metal alloy. Still, metals have low yielding stress and creep resistance at typical SOFC operation temperatures. The various metallic components of the stack will deform over time, causing sealing failure or loss of electrical contact.

While infiltration fabrication method alleviates several challenges faced by conventional ceramic anode supported cell such as redox instability, CTE mismatch between anode and cathode, high electrode electrical resistance, and some fabrication constraints, the stack assembly nevertheless faces challenges. Specifically, the difficulties include: 1). production of flat cells for assembly into stack, and keeping cell flat during operation, 2). maintaining good electrical contact between cell and interconnect, 3). glass seal between layers prone to cracking under thermal cycle, 4). thick structural support layer that increases gas diffusion resistance, and 5). metallic interconnect inevitably developing oxide scale over lifespan that increases contact electrical resistance and eventually resulting in stack failure. These mechanisms can cause cells generating 30-50% less power when integrated into a stack. Metallic interconnects typically limit SOFC operation temperature below 700-800° C., limiting electro-chemical performance. Oxidation, even at lower operation temperature such as 700° C., generally limits the operation lifespan to less than 40 k hours.

Ceramic interconnects are much more desirable for high temperature stability and lower degradation. Furthermore, ceramic interconnects may be co-sintered with cells forming fully bonded monolithic ceramic stacks, eliminating the needs of glass seals between components and the compression loading.

As much as the technical challenges, the economical challenge of producing low cost SOFC stack remains the main barrier for SOFC commercialization. A study by Battelle Memorial Institute, commissioned by US DOE (Manufacturing Cost Analysis of 100 and 250 kW Fuel Cell Systems for Primary Power and Combined Heat and Power Applications, 2016) shows that 45% of the stack cost are cells, while 55% are various other stack components and the assembly process. Furthermore, only 20% of overall stack cost are from cell materials. Besides the cells, main costs of an SOFC stack are the material and manufacturing costs of interconnect, electrode frames/spacer, glass seals between contact surfaces of components, current collector/electrical contact meshes, high temperature creep resistant end plates and bolts, and assembly labor costs. These costs are directly related to the complexity of stack design.

In view of the foregoing, the industry continues to have a need for improved SOFC stacks to achieve low cost, high performance, and reliable SOFC products.

In the present invention, a simple and low cost SOFC stack design and a processing method are disclosed. A SOFC stack is fabricated by first forming a stack scaffold with bonded structure comprising thick bulk electrode scaffolds (electrodes being anode and cathode), thin functional electrode scaffolds, electrolytes, and thin ceramic interconnects. Electro-chemically active catalytic phases are infiltrated into bulk and functional electrode scaffolds to form a functional SOFC stack. The bulk and functional electrode scaffolds and electrolyte are formed with the same ceramic or material of substantially similar sintering shrinkage and thermal expansion coefficients, with the bulk electrodes serving as the structural support. The interconnect and electrolyte are formed as thin ceramic layers. The process forms a monolithic bonded all ceramic SOFC stack.

The present invention is directed to the design of and process for forming a monolithic electrode supported electro-chemical device stack, specifically a solid oxide fuel cell stack. A stack, such as the example in FIG. 2, includes multiple repeating cells (202) stacked in serial separated by, and rigidly bonded with, interconnects (203), whereas an interconnect is sandwiched between a first cell's anode and its neighboring cell's cathode. The top and bottom surfaces of the stack are bonded with end interconnects (201) preventing gas leakage from porous layers in the underlying cells.

Each cell comprises a bulk anode (302), a functional anode (303) overlying the bulk anode, an electrolyte (304) overlying the functional anode, a functional cathode (305) overlying the electrolyte, and a bulk cathode (306) overlying the functional cathode. The second and all other cells comprise the same structure. Cell components are first formed as green layers. Green bulk electrode layers and green functional electrode layers contain pore formers to produce porosity, electrodes including anode and cathode. The green electrode layers are sintered into porous backbone structures, the anode scaffold and cathode scaffold, into which catalysts are infiltrated to form electro-chemically active anode and cathode.

The bulk electrode scaffolds, functional electrode scaffolds, and electrolyte are composed of oxygen ion conductive metal oxides, such as yttria-stabilized zirconia (YSZ).

Reference herein to “green” articles is reference to materials that have not undergone sintering. A green article can have suitable strength to support itself and other green layers formed thereon.

The formed cell scaffold, formed by sintered electrode scaffolds and electrolyte, is composed of the same material or material of substantially similar sintering shrinkage and thermal expansion coefficients, but different porosity levels in different components. This ensures uniform deformation during sintering and post-sinter cool-down without generating internal thermal stress, which contrasts with most SOFC cell forming processes having differential sinter shrinkage and thermal expansion coefficients between layers, generating thermal stresses that can result in cracking.

Green cells are assembled with green interconnect layers into a green stack, wherein the green interconnect layers are sandwiched between green cells. The green stack is subsequently fired to form a fully bonded stack scaffold, wherein the interconnect layers are non-porous or without open porosity. The interconnect comprises conductive metal oxide ceramics that are stable in both oxidizing and reducing environment, such as niobium dopped lanthanum-doped strontium titanate (LSTN). Because ceramics have much lower electrical conductivity than metals, the ceramic interconnect must be very thin, such as 5-50 μm, to minimize electronical resistance. The ceramic interconnect should be formed with cells in green state and sintered with the cells, forming a monolithic bonded stack structure. The interconnect material should have substantially similar sintering shrinkage and thermal expansion coefficient as these of electrode scaffold and electrolyte materials.

In the current stage of fabrication, active catalytic materials, such as LSM or Ni, have not been introduced to the cell or stack. The electrode scaffold and electrolyte generally comprise of the same material, or materials of substantially the same sintering shrinkage and thermal expansion coefficient, ensuring uniform deformation during sintering and post-sintering cool-down. Sintering condition can be tailored to fully densifying electrolyte and interconnect layers, without concerns of adverse effect, such as inter-diffusion or undesirable chemical reaction. For example, sintering can be performed at high temperatures such as 1400° C. or even 1700° C.

Notably certain characteristics of the green electrolyte, green electrode scaffold material, and green interconnect material, including for example, a combination of morphological characteristics, physical characteristics, and chemical characteristics of the material can be used to facilitate the sintering process having the characteristics described herein. Without wishing to be tied to a particular theory, it is thought that a combination of characteristics, such as particular size distribution of the powder component, packing factor, porosity, chemical composition of each of the layers, thermal expansion properties, and free sintering shrinkage rate, and the like can facilitate a free-sintering process, wherein the cell and entire stack deform substantially uniformly during free-sintering process and post-sintering cool-down.

Several benefits are realized:
a). The electrode scaffolds and electrolyte are composed of the same material or materials of substantially similar sintering shrinkage and thermal expansion coefficient, ensuring uniform deformation during fabrication processes.
b). Infiltrated catalysts, which are different for anode and cathode, form thin nano-scale coating on electrode scaffolds, having little impact on the thermal expansion coefficient of the formed components, ensuring uniform deformation during operation thermal cycle.
c). Strong scaffold structure and diffusion bonding between layers are formed by high temperature sintering, ensuring good mechanical strength and electrical conduction, which is generally not present in ceramic structures formed by low temperature process or by bonding pre-sintered ceramics.

Gas channels (310) are formed in the bulk electrodes (302), (306) to facilitate gas delivery to and removal from functional electrodes. Gas channels are formed for example through channel formers embedded in green bulk electrode layers. Channel formers may be removed through a subtractive process such as oxidation to leave channels. The channel formers can take the shapes of cylindrical rod, rectangular rod, or other shapes, and would be that the material would burn out during firing process and not be reactive with metal or ceramic materials. The channels are generally greater than 0.2 mm in cross-section to reduce pressure drop, but less than the thickness of the layer they are embedded in. The embedded channels provide benefits compared with conventional planar stack in a). forming an I-beam like structure that increases bending rigidity at similar weight, b). placing gas channels closer to functional electrodes, reducing diffusion resistance, and c). no electrode frames or sealing needed between cell and interconnect, or around gas channels within the stack, reducing stack complexity and cost.

In the stack disclosed in the present invention bulk electrodes and functional electrodes are porous and extend to edges of cells and stack. The sintered stack exterior surfaces should be coated with a hematic coating. Generally, the coating layer comprises of green glass or glass ceramics that are fired to dense coating. Firing temperatures (500-1000° C.) are generally significantly lower than cell sintering temperatures (1200-1600° C.), having minimal influence on cell dimensions or microstructures. The coating can remain rigid at SOFC operation temperatures, allowing ceramic materials, such as YSZ, in additional to glass or glass ceramic materials. The requirements for the coating layers are that they form hermetic layer after firing, stable in oxidizing and reducing environment, electronically low conductivity, non-reactive to ceramics and catalysts, and having a thermal expansion coefficient that is substantially the same or slightly smaller than CTE of electrode scaffolds.

The method for forming a monolithic electrode supported electro-chemical device stack further includes infiltrating catalyst precursors into functional electrode scaffolds through gas channels and porosity in bulk electrode. After the infiltration, the stack is heat-treated to convert precursors to catalysts. The catalysts being cathode catalyst or anode catalyst. The precursors can be metal nitrate solutions of intended stoichiometric composition. For example, an anode catalyst precursor can comprise nickel nitrate, yttrium nitrate, and zirconium nitrate, which after heat treatment are converted to NiO/YSZ catalyst. A cathode precursor can comprise lanthanum nitrate, strontium nitrate, and manganese nitrate, which after heat treatment are converted to LSM catalyst. The catalysts are formed as nano-scale particulate coating on the electrode scaffold pore surfaces.

The process disclosed in the present invention forms a monolithic electro-chemical device stack, eliminating the need for stack components such as electrode frames, inter-component seals, or compression end plates. Being a rigid single piece of solid, compression loading is not needed. Design complexity and stack cost are significantly reduced compared with conventional planar stacks.

Furthermore, the rigid stack structure is mechanical strong and reliable against external loads such as shock/vibration and handling. The solid oxide fuel cell stack disclosed in this invention can additionally withstand internal pressure for using pressurized gas infeed to increase stack operating voltage, power density and efficiency.

### BRIEF DESCRIPTION OF THE DRAWINGS

FIG. 1 shows a conventional anode supported conventional SOFC stack.

FIG. 2 shows a monolithic electrode supported electro-chemical device stack with gas channels embedded in bulk electrodes, arranged in cross-flow configuration.

FIG. 3 shows the same stack in partially exploded view to further illustrate the detailed structure in a cell.

FIG. 4 shows an example of a flow diagram illustrating a fabricating process for a monolithic electrode supported electro-chemical device stack.

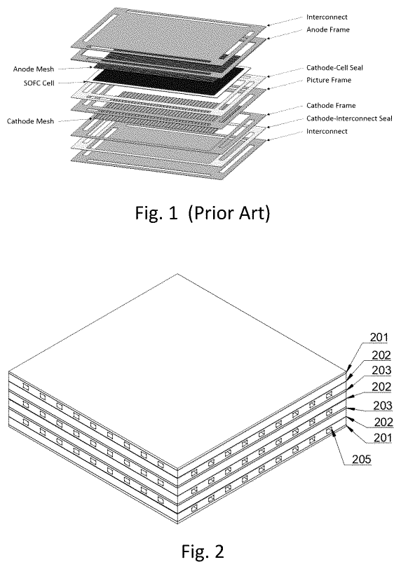

### DETAILED DESCRIPTION OF THE INVENTION

Reference will now be made in detail to some specific details of the invention including the stack design and forming processes. Examples of these specific embodiments are illustrated in the accompanying drawings and descriptions. It will be understood that it is not intended to limit the invention to the described embodiment. On the contrary, it is intended to cover alternatives, modifications and equivalents as may be included within the scope of the inventions as defined by the claims. Particular embodiments of the present invention may be implemented without some of all of the provided details. In other instances, well known processes have not been described in detail in order not to unnecessarily obscure the present invention. The term “about” or “approximate” and like are used to indicate that the value modified by the term has an understood range associated with it, where the range can be ±20%, ±10%, ±5%, or ±1%. The term “substantially” is used to indicate that a value is close to a targeted value, where close can mean the value is within 80%, 85%, 90%, 95%, or 99% of the targeted values.

Typical compositions used in electro-chemical devices such as solid oxide fuel cell or solid oxide electrolysis cell are represented by their commonly used symbols. Some examples are: YSZ—yttria-stabilized zirconia, typically 8 mol % Y (8YSZ), ScSZ—scandia stabilized zirconia, typically 10 mol % Sc, can also contain 1% Ce (10ScSZ, 10Sc1CeSZ), SDC—samaria-dopped ceria, typically 20 mol % Sm, GDC—gadolinium-dopped ceria, typically 20 mol % Gd. LSM—lanthanum strontium manganite, typically 20 mol % La. LSC—lanthanum strontium cobaltite, typically 20% La. LSCF—lanthanum strontium cobalt ferrite, typically 60 mol % La and 20 mol % Co. LST—lanthanum strontium titanate (LST), typically 20 mol % La. LSTN—niobium dopped lanthanum strontium titanate, typically 2-10 mol % Nb.

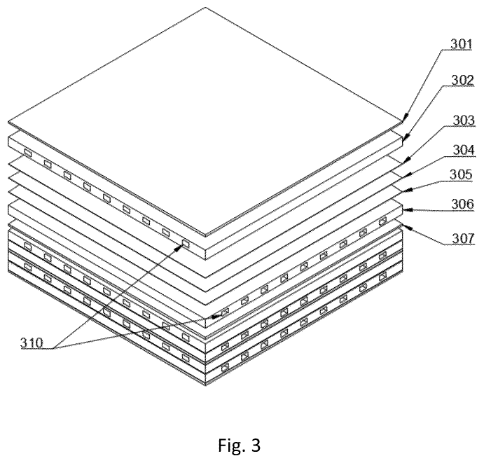

An SOFC stack described in the present invention has gas channels embedded in bulk electrodes (FIG. 2 and FIG. 3). Multiple cells (202) are connected in serial by, and bonded with, interconnects (203). End interconnects (201) are bonded to the top and bottom surfaces.

Each of the cells has a bulk anode, a functional anode over the bulk anode, an electrolyte over the functional anode, a functional cathode over the electrolyte, a bulk cathode over the functional cathode. The components described according to the embodiments herein are flat layers parallel to each other. The layers can be formed through techniques including, but not limited to, casting, deposition, printing, extruding, laminations, die-pressing, gel casting, spray coating, screen printing, roll compaction, 3D printing, and a combination thereof. In one embodiment, each of the layers can be formed via screen printing. In another embodiment, each of the layers can be formed via tape casting. In another embodiment, each of the layers can be formed via extrusion.

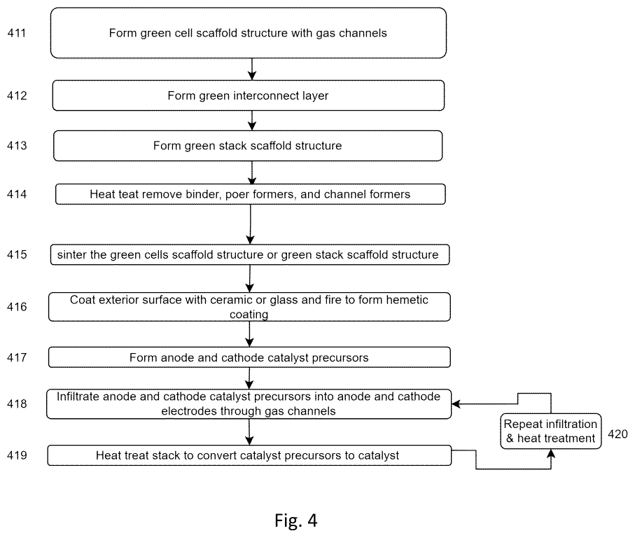

An electro-chemical device stack can be formed through the following steps (FIG. 4):

At block (411), form a green cell with gas channels, comprising: a). form green bulk anode and bulk cathode layers with binder and pore formers (10-100 μm average size), with post sinter thickness 0.5-5 mm. The layers further include gas channels (310) of 0.2-2 mm in cross-section. Gas channels can be formed by any suitable techniques known in the art. Such as, for example, incorporating shaped fugitives, embossing, cutting channels in tapes and then laminating the tapes to define channels, using extrusion through preforms, or using patterned rolls in roll compaction. In a particular embodiment, the gas channels are formed through the inclusion of channel former in green bulk electrode layers, such as taking the shape of cylindrical or rectangular rod, or other channel cross-section that minimizes pressure drops. In a particular embodiment, the gas channels are straight, while in other embodiments, the gas channels can take other shapes and arrangements to facilitate sufficient gas delivery across the entire cell area. b). form green functional anode and functional cathode layers with the same material as the green bulk electrode layers with binder and pore former (1-20 μm average size), with post sinter thickness 10-100 μm. c). form green electrolyte layer with the same material or material of substantially similar sintering shrinkage and thermal expansion coefficient as green electrode layers, electrode being anode and cathode respectively, but without pore former, with post sinter thickness 5-50 μm. d), laminate the layers in the sequence (FIG. 3) of bulk anode layer (302), functional anode layer (303), electrolyte layer (304), functional cathode layer (305), bulk cathode layer (306), to form a green cell. The green bulk electrodes, functional electrodes, and electrolyte material can be selected from suitable oxygen ion conductive metal oxides such as YSZ, SDC, GDC, ScSZ, ScCeSZ, and others.

At block (412), the procedure further includes: forming a green interconnect layer with binder but no pore former, with post sinter thickness 5-50 μm. The interconnect material can be selected from conductive metal oxides, such as LaSrCrO₃, LaMgCrO₃, LaCaCrO₃, YCrO₃, LaSrTiO₃. In particular, the interconnect can comprise La_{0.2}Sr_{0.8}TiO₃, having one or more dopants, and may consist essentially of Nb dopped LST.

At block (413), multiple green cells and green interconnect layers are laminated in serial to form a green stack. A green stack can contain 2 to 200 cells, or more than 200 cells. Additional green interconnect layers are placed on the top and bottom surfaces of the stack to form hermetic layers post sintering.

At block (414), the green stack is heated in air to about 200-550° C. for 0.5-2 hours to remove binder, pore formers, and channel formers. Generally, the only limitation on the selection of materials forming the pore former and channel former would be that the material would burn out during the heating process, and that the material is not reactive with ceramic and metal materials. The conditions are satisfied by materials such as carbon black, graphite, synthetic rubber, thermoplastics.

At block (415), the green stack is sintered to stack scaffold in air. The “scaffold” herein is reference to cell or stack structure having porous electrode backbones, electrode being anode and cathode, but without active catalysts. The sintering temperature can be between 1200° C. and 1700° C. For example, in one embodiment, sintering is performed at 1400° C. for 2 hours. Sintered electrolyte and interconnect should be non-porous or without open porosity. Sintered bulk and functional electrode scaffolds generally have a high volume of porosity to allow diffusion of gaseous species. According to one embodiment, the percent porosity of the formed bulk electrodes is not less than 30-50%. According to another embodiment, the percent porosity of the formed functional electrodes is not less than 15-35%.

The absence of catalytic materials, such as LSM or Ni, in the current step of fabrication allows for higher sintering temperature without adverse effects, such as diffusion of Mn into YSZ, or formation of insulating LZO phase, that often are constraints in other SOFC processing methods. The sintering conditions can be specifically designed to be suitable for the full densification of electrolyte and interconnect layers. A high sintering temperature, such as above 1400-1700° C., ensures that the formed electrode scaffold structure having high strength and strong diffusion bonding between layers.

At block (416), coat the formed stack scaffold exterior surfaces with green ceramic, glass, or glass ceramic layer by any suitable techniques known in the art. Such as, for example, dip-coating, spray-coating, roller-coating. After the coating step, the stack is fired at an appropriate temperature to form hematic coating, preventing the leakage of gas from the porous layers. While glass or glass-ceramics are generally used, low electronic conductivity ceramic that remains rigid at operation temperature can also be used, such as YSZ. The coating material should have a thermal expansion coefficient that is substantially similar as, or slightly smaller than, the CTE of electrode scaffold.

At block (417), a cathode catalyst precursor and an anode catalyst precursor are provided. In some embodiments, the catalyst precursor each comprises metal nitrates, a surfactant, and solvent. For example, in some embodiments, a cathode catalyst precursor comprises lanthanum nitrate, strontium nitrate, and manganese nitrate in stoichiometric composition ratio for converting to La_{0.8}Sr_{0.2}MnO_{3-δ} catalyst after heat treatment. In another example, in some embodiments, an anode catalyst precursor comprises samarium nitrate, cerium nitrate, and nickel nitrate in stoichiometric composition for converting to Sm_{0.2}Ce_{0.8}O_{1.9}/Ni catalyst after heat treatment. Generally, the nitrates should be dissolved close to the maximum solubility to deliver the most catalyst precursor content in each infiltration. The resulted solutions generally have 1-4 mol/L of catalyst concentration.

At block (418), anode catalyst precursors are infiltrated into anode scaffold through gas channels embedded on the anode side. Cathode catalyst precursors are infiltrated into cathode scaffold through gas channels embedded on the cathode side. In some embodiments, volume inside the stack, or area on exterior of the stack, that are not intended to be infiltrated, such as the top and bottom surfaces, are protected with a mask such as polymer-based paint or plastic film. The masks will burn away during heat treatment. Infiltration can be performed, for example, by injecting precursor solution into channels directly or dipping the stack into precursor solution. In some embodiments, a vacuum pressure can be applied before or during the infiltration process to remove air and facilitate solution penetration into pores.

At block (419), the infiltrated stack is heated to about 600° C. to 1000° to convert precursors to nano-particulate catalyst coating on the pore walls of electrode scaffold, converting the stack scaffold to an electro-chemically active SOFC stack. The heat treatment is performed for about 30 minutes to 2 hours. The catalysts in anode and cathode should provide at least one of an electronic conduction pathway, an ionic conduction pathway, and catalytic surfaces, and typically provide all three. In some embodiments the cathode catalyst is selected from a group consisting of lanthanum strontium manganite (LSM), lanthanum strontium cobaltite (LSC), lanthanum strontium ferrite (LSF), samarium strontium cobaltite (SSC), lanthanum strontium cobalt ferrite (LSCF), barium strontium cobalt ferrite (BSCF), samarium strontium cobaltate (SSC), praseodymium nickel oxide (PNO), praseodymium oxide (POx), samarium doped ceria (SDC), gadolinium doped zirconia (GDC), yttria-dopped zirconia (YSZ), and mixtures thereof. In some embodiments, the anode catalyst is selected from a group consisting of nickel strontium titanate, lanthanum strontium titanate, yttrium strontium titanate, niobium titanate, strontium manganese magnesium oxide, nickel and samaria or yttria doped ceria, and mixtures thereof. In some embodiments, composite catalysts can be desirable, recognizing that certain constituent may contribute to one of electronic conductivity, ionic conductivity, and electrocatalysis functions. For example, in one embodiment, an anode catalyst comprises YSZ and Ni. In another embodiment a cathode catalyst comprises LSM and YSZ. In one embodiment, additional Ni is infiltrated to enhance reforming catalytic capability for complex fuels such as natural gas, ammonia, kerosene, methane, propane, ethanol, methanol, propanol and mixtures thereof.

At block (420), the filtration and heat treatment procedures can be repeated several times until the target amounts of catalysts are infiltrated, such as 20 vol %. In some embodiments, the infiltration and heat treatment are repeated 1-10 times for anode catalyst. In some embodiments, the infiltration and heat treatment are repeated 1-10 times for cathode catalyst. In some embodiments, the formed particles remain smaller than about 50-500 nm. After each heat treatment, excess catalysts are removed from the exterior surfaces and from within gas channels to reduce potential impact on electro-chemical performance and allow for good gas transportation into porous layers. For example, this can be done by blowing compressed air on the exterior surfaces and through gas channels.

A SOFC stack fabricated by performing the methods described in FIG. 4 comprises multiple cells in serial arrangement connected by interconnects. The cells and interconnect layers are co-sintered, forming a rigid monolithic structure. Each cell comprises a bulk anode, a functional anode, an electrolyte, a functional cathode, and a bulk cathode. In some embodiments, the bulk anode and bulk cathode are of substantially same thickness and are about 0.5-5 mm thick, or about 1-3 mm thick. In some embodiments, the functional anode and functional cathode are of substantially same thickness and are about 10 mm-100 μm thick, or about 20-50 μm thick. In some embodiments, the electrolyte is about 5-50 μm thick, or about 5-20 μm thick. In some embodiments, the interconnect is about 5-50 μm thick, or about 5-20 μm thick.

The SOFC stack further comprises gas channels embedded in bulk anode and bulk cathode to facilitate gas delivery and removal from functional electrodes. The formed SOFC stack is covered with hermetic coating on the exterior surfaces. Catalysts are infiltrated into porous electrodes through gas channels and porous bulk electrodes.

The embodiments herein represent departure from the state of art. While sintering of multiple layers of SOFC cells and interconnects had been attempted, none of these processes have utilized a free sintering or infiltration processes including the combination of features disclosed herein. Notably, according to the embodiments herein, such features include, but are not limited to, forming a stack scaffold with porous electrode backbone into which catalysts are infiltrated, forming diffusion bonds at high temperature between interconnect and cell electrode backbone, symmetric structure of each cell, and gas channel embedded in bulk electrodes. The present invention discloses a streamlined process for forming a SOFC stack including new process features facilitating improved SOFC stack mechanical and electrical characteristics, reducing complexity and costs.

The examples of the embodiments disclosed are not intended to be limiting. They are related to the design and fabrication of solid oxide fuel cell stacks. The method described, however, are applicable to other solid state electrochemical devices such as solid oxide electrolysis cells and regenerative or reversible fuel cell/electrolysis cells.

The above-disclosed subject matter is to be considered illustrative, and not restrictive, and the appended claims are intended to cover all Such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description. In the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately claimed subject matter.

### REFERENCES

| | | | |
|---|---|---|---|
| U.S. Pat. No. 4,421,787A | A | December 1983 | Ikezawa |
| U.S. Pat. No. 4,913,982 | A | April 1990 | Kotchick |
| U.S. Pat. No. 5,162,167 | A | November 1992 | Minh |
| U.S. Pat. No. 5,508,127 | A | April 1996 | Lewin |
| U.S. Pat. No. 6,106,967 | A | August 2000 | Virkar |
| U.S. Pat. No. 6,228,520 | B1 | May 2001 | Chiao |
| U.S. Pat. No. 66,489,296 | B1 | November 2003 | Minh |
| U.S. Pat. No. 7,550,217 | B2 | June 2004 | Kwon |
| U.S. Pat. No. 6,855,451 | B2 | February 2005 | Ghosh |
| U.S. Pat. No. 6,896,989 | B2 | May 2005 | Hara |
| U.S. Pat. No. 7,070,879 | B2 | July 2006 | Mardilovich |
| U.S. Pat. No. 8,459,467 | B2 | December 2008 | Reilly |
| US20100183947 | A1 | July 2010 | Mohanram |
| US20100178589 | A1 | July 2010 | Kwon |
| U.S. Pat. No. 7,767,358 | B2 | August 2010 | Seabaugh |
| US20110111320 | A1 | May 2011 | Suda |
| US20130093129 | A1 | October 2011 | Mohanram |
| US2013177831 | A1 | July 2013 | Lin |
| U.S. Pat. No. 8,921,007 | B2 | December 2014 | Lin |
| U.S. Pat. No. 8,999,601 | B2 | April 2015 | Gottmann |

High Temperature Solid Oxide Fuel Cells, S. Singhal, 2003
Characterization of Sr-Doped LaCoO3-YSZ Composites Prepared by Impregnation Methods, Journal of The Electrochemical Society, 2004, 151, A1592
The effect of electrode infiltration on the performance of tubular solid oxide fuel cells under electrolysis and fuel cell modes, International Journal of Hydrogen Energy, 2014, 39(5), 8002

1. A monolithic electrode supported electro-chemical device stack comprising:
a). a plurality of cells, each cell including, a bulk anode, a functional anode over the bulk anode, an electrolyte over the functional anode, a functional cathode over the electrolyte, and a bulk cathode over the functional cathode;
b). the anode, cathode, bulk anode, and bulk cathode comprise of porous scaffold and electro-chemically active catalyst particulate coating on the scaffold pore surfaces;
c). planer ceramic interconnects between the cells, bonded to bulk anode of a first cell and bulk cathode of a second cell;
d). cells and interconnects are substantially parallel to each other and form a planar stack of cells, stacked one on top of another bonded by interconnects;
e). a planar ceramic interconnect bonded to the top surface of the formed stack, and a planar ceramic interconnect bonded to the bottom surface of the formed stack;
f). an electronically insulating hermetic coating on the exterior surfaces of the stack, except for part of the top and bottom surfaces.

2. The stack of claim 1, wherein the bulk anode and bulk cathode are porous, and have porosity between 20% and 50%.

3. The stack of claim 1, wherein the bulk anode and bulk cathode have thicknesses between 0.5 mm and 5 mm, preferably of substantially similar thicknesses.

4. The stack of claim 1, wherein the functional anode and functional cathode are porous, and have porosity between 10% and 30%.

5. The stack of claim 1, wherein the functional anode and functional cathode have thicknesses between 10 μm and 100 μm, preferably of substantially similar thicknesses.

6. The stack of claim 1, wherein the electrolyte is non-porous or without open porosity.

7. The stack of claim 1, wherein the electrolyte has thickness between 5 μm and 50 μm.

8. The stack of claim 1, wherein the anode scaffold, cathode scaffold, bulk anode scaffold, bulk cathode scaffold, and electrolyte are of the same material or materials having substantially similar sintering shrinkage and thermal expansion coefficients.

9. The method of claim 1, wherein the anode scaffold, cathode scaffold, bulk anode scaffold, bulk cathode scaffold, and electrolyte materials are oxygen ion conductive metal oxides.

10. The stack of claim 1, wherein interconnect is non-porous or without open porosity.

11. The stack of claim 1, wherein the interconnect has thickness between 5 μm and 50 μm.

12. The stack of claim 1, wherein interconnect material has sintering shrinkage and thermal expansion coefficient that is substantially similar as anode and cathode scaffold material.

13. The stack of claim 1, wherein interconnect material is electronically conductive metal oxides, preferably Sr-titanate (Sr TiO3) with a n-dopant, including LaₓSr₁₋ₓNbyTiO₃ where x is between 0.01 and 0.5 and y is between 0.01 and 0.25.

14. The stack of claim 1, wherein the hermetic coating has thickness of between 10 μm and 1 mm.

15. The stack of claim 1, wherein the hermetic coating has a thermal expansion coefficient that is substantially the same as, or slightly smaller than, the CTE of electrode scaffold material.

16. The stack of claim 1, wherein coating material is glass, glass ceramics, or electronically insulating ceramics.

17. A monolithic electrode supported electro-chemical device stack of claim 1 further comprises gas channels formed within bulk electrodes.

18. The stack of claim 17, wherein gas channels are formed in either cross-flow or counter-flow arrangements.

19. The stack of claim 17, wherein gas channels have circular, elliptical, rectangular or other cross-section shapes, and cross-section sizes not smaller than 0.2 mm and not greater than the thickness of the layers they are embedded in.

20. A method for forming a monolithic electrode supported electro-chemical device stack comprising forming a stack scaffold:
a). forming a first green cell scaffold, the first green cell scaffold having a green bulk anode scaffold, a green functional anode scaffold over the bulk anode scaffold, a green electrolyte over the functional anode scaffold, a green functional cathode scaffold over the electrolyte, and a green bulk cathode scaffold over the cathode scaffold;
b). forming a green ceramic interconnect over the first green cell scaffold;
c). forming a second green cell scaffold over the green interconnect, the second green cell scaffold having a green bulk anode scaffold, a green functional anode scaffold over the bulk anode scaffold, a green electrolyte over the functional anode scaffold, a green functional cathode scaffold over the electrolyte, and a green bulk cathode layer over the cathode scaffold;
d). repeat b) and c) for all other green cell scaffolds and green interconnects with the same process and structure to form a green stack scaffold;
e). free sintering the green stack scaffold into stack scaffold at temperature between 1200°-1700° C. in air for between 30 minutes and 5 hours;
f). coating the sintered stack scaffold exterior surfaces with green ceramic, glass, or glass ceramic;
g). firing the stack scaffold at temperature between 500° and 1000° to form hermetic surface coating.

21. The method of claim 20, wherein forming the green cells comprises tape casting or screen printing of the green bulk electrode scaffold, green functional electrode scaffold, and green electrolyte, and green interconnect to form the green cells and stack prior to sintering.

22. The method of claim 20, wherein the green bulk electrode scaffold and green functional electrode scaffold are formed with pore formers; the green electrolyte and interconnect are formed without pore former.

23. The method of claim 20, wherein gas channels are formed in the green bulk electrode scaffolds.

24. The method of claim 20, wherein the cells and interconnects are diffusion bonded after sintering.

25. A method for forming a monolithic electrode supported electro-chemical device stack in claim 20 further comprising:
a). providing a stack scaffold having porous bulk electrode scaffolds, porous functional electrode scaffolds, dense electrolyte, dense interconnects, and embedded gas channels;
b). providing an anode catalyst precursor and a cathode catalyst precursor;
c). infiltrating the anode catalyst precursor through the gas channels embedded in bulk anode scaffold;
d). infiltrating the cathode catalyst precursor through the gas channels embedded in bulk cathode scaffold;
e). heating the stack to between 500° C. and 1000° C. for between 10 minutes to 5 hours to convert precursors to catalysts, and henceforth convert the stack scaffold to an active stack.

26. The method of claim 25, wherein infiltrations are performed in a vacuum between 100-300 mbar.

27. The method of claim 25, wherein operations c), d), and e) are repeated until specific amount of the anode catalyst and cathode catalyst are deposited into electrode scaffolds.

28. The method of claim 25, wherein the anode and cathode catalyst precursors comprise metal nitrate solution in sociochemical compositions that are converted to anode and cathode catalysts after heat treatment, respectively.
